(19) United States
(12) Patent Application Publication
(10) Pub. No.: US 2012/0264027 A1
(43) Pub. Date: Oct. 18, 2012

(54) FUEL-CELL BIPOLAR PLATE AND FUEL CELL USING THE SAME

(75) Inventors: Takaaki MIZUKAMI, Hitachi (JP); Shuichi Suzuki, Hitachinaka (JP); Yoshiyuki Takamori, Hitachinaka (JP)

(73) Assignee: Hitachi, Ltd.

(21) Appl. No.: 13/449,336

(22) Filed: Apr. 18, 2012

(30) Foreign Application Priority Data
Apr. 18, 2011 (JP) 2011-091763

(51) Int. Cl. H01M 8/06

(52) U.S. Cl. 429/427

(57) ABSTRACT

Disclosed is a bipolar plate for a fuel cell including a bipolar plate substrate; and a byproduct-decomposing layer covering the bipolar plate substrate, the bipolar plate has channels for transport of a reactant gas, the channels being arranged on a surface of the bipolar plate substrate, and the bipolar plate has a first side to face an anode catalyst layer of the fuel cell and a second side to face a cathode catalyst layer of the fuel cell. The byproduct-decomposing layer is arranged on at least one of the first side and the second side, includes a catalyst, and is capable of decomposing a byproduct formed as a result of a reaction of the fuel cell. The bipolar plate enables long-term control of discharge of formic acid and other byproducts without deterioration in system efficiency of the fuel cell.

### CLAIM OF PRIORITY

The present application claims priority from Japanese Patent application serial No. 2011-091763, filed on Apr. 18, 2011, the content of which is hereby incorporated by reference into this application.

### BACKGROUND OF THE INVENTION:

1. Field of the Invention

The present invention relates to a bipolar plate (separator) for a fuel cell, and a fuel cell using the bipolar plate.

2. Description of Related Art

Global warming and environmental pollution due to heavy consumption of fossil fuels have become serious more and more.

As a possible solution to these issues, fuel cells have received attention as an alternate for fossil fuels. Such fuel cells use, for example, hydrogen or methanol as a fuel instead of fossil fuels; and oxygen or an oxygen-containing gas such as air as an oxidizing agent. Exemplary fuel cells include polymer electrolyte fuel cells and solid oxide fuel cells.

The fuel cells are clean and efficient power generation systems, since discharges of power generation by the fuel cells give less load on the environment. In particular, there are attempts to apply the fuel cells to high-energy-density power sources for mobile devices.

With recent advance in electronics technologies, the amount of information increases more and more, and enormous information should be processed at higher speed with higher functionality. This requires power sources having a high output density and a high energy density, i.e., power sources capable of being driven continuously over a long term period. In addition, the necessity to provide compact power generators requiring no charging, i.e., micropower generators enabling easy refueling becomes greater and greater.

Under these circumstances, investigations on the fuel cells increase in importance.

The fuel cells are power generators which have a structure including at least a solid or liquid electrolyte, and two electrodes, i.e., an anode and a cathode, inducing desired electrochemical reactions and which highly efficiently convert chemical energy of the fuel directly into electric energy.

Of fuel cells, those using a polymer electrolyte membrane as an electrolyte membrane and hydrogen as the fuel are called polymer electrolyte fuel cells (PEFCs), whereas those using methanol as the fuel are called direct methanol fuel cells (DMFCs). Among them, the DMFCs using the liquid fuel have a high volume energy density of the fuel and receive attention as compact mobile or portable power sources.

In the DMFCs, methanol fed to the anode is oxidized to be carbon dioxide, which is discharged; whereas methanol migrating from the anode through the polymer electrolyte to the cathode is oxidized by oxygen fed to the cathode to be carbon dioxide, which is discharged. In these methanol oxidizing processes, considerable amounts of intermediates such as formic acid and formaldehyde are formed as byproducts and discharged from the fuel cell. Formic acid should be minimized in amount, because it is harmful to the human body.

For example, Japanese Patent Application Laid-Open No. 2008-210796 (Document 1) discloses a filter for removing harmful substances such as formic acid discharged from a fuel cell. The filter uses a byproduced-gas absorbent containing an organic acidic gas deodorant, and an aldehyde-gas absorbent including an aminoguanidine salt and/or a hydrazide compound. The filter is to be arranged in an exhaust-gas piping.

Japanese Patent Application Laid-Open No. 2005-183014 (Document 2) discloses a filter for removing harmful substances, the filter including a catalyst for oxidizing such substances as formic acid and formaldehyde.

### SUMMARY OF THE INVENTION

An aspect of the present invention provides a bipolar plate for a fuel cell including a bipolar plate substrate; and a byproduct-decomposing layer covering the bipolar plate substrate, the bipolar plate has channels for transport of a reactant gas, the channels being arranged on a surface of the bipolar plate substrate, and the bipolar plate has a first side to face an anode catalyst layer of the fuel cell and a second side to face a cathode catalyst layer of the fuel cell. The byproduct-decomposing layer is arranged on at least one of the first side and the second side, includes a catalyst, and is capable of decomposing a byproduct formed as a result of a reaction of the fuel cell.

The present invention can increase a system efficiency of the fuel cell and can control the discharges of formic acid and other byproducts over the long term.

### BRIEF DESCRIPTION OF THE DRAWINGS

FIG. 1 is an exploded perspective view illustrating an embodiment of a structure of a bipolar plate.

FIG. 2 is an exploded perspective view illustrating a fuel cell.

FIG. 3 is a cross-sectional view illustrating an embodiment of the bipolar plate of FIG. 1 taken along the line A-A′.

FIG. 4 is a cross-sectional view illustrating another embodiment of the bipolar plate of FIG. 1 taken along the line A-A′.

FIG. 5 is a cross-sectional view illustrating still another embodiment of the bipolar plate of FIG. 1 taken along the line A-A′.

FIG. 6 is a schematic cross-sectional view illustrating a fuel cell used in evaluations of samples according to working examples and a comparative example.

FIG. 7 is an exploded perspective view illustrating another embodiment of the structure of the bipolar plate.

FIG. 8 is a cross-sectional view of the bipolar plate of FIG. 7 taken along the line B-B′.

### DETAILED DESCRIPTION OF THE PREFERRED EMBODIMENTS

The present invention relates to a fuel cell including at least an anode (anode catalyst layer), an electrolyte membrane, a cathode (cathode catalyst layer), a gas diffusion layer and a bipolar plate (separator), in which a fuel is oxidized in the anode, and oxygen is reduced in the cathode; and to a fuel cell stack including a plurality of the fuel cell being stacked. The present invention also relates to power generators and compact portable power sources each including the fuel cell, and to electric appliances or electronic appliances using these power sources.

The absorbent disclosed in Document 1 has a limitation in adsorption and is susceptible to improvements in long-term efficiency of removal typically of formic acid.

The filter for removing harmful substances disclosed in Document 2 includes a casing to be arranged in the piping; and a catalyst unit charged in the casing. Since the filter causes flow resistance (pressure loss) of an exhaust gas, a blower to be used should therefore have higher performance, and this increases a loss due to auxiliary power. For these reasons, this technique still suffers from insufficient efficiency of the fuel cell system.

Accordingly, an object of the present invention is to increase the system efficiency of the fuel cell and to control discharges of formic acid and other byproducts over the long term.

A bipolar plate for a fuel cell (hereinafter also briefly referred to as a “fuel-cell bipolar plate”) and a fuel cell using the bipolar plate will be illustrated below as embodiments according to the present invention.

The fuel-cell bipolar plate includes a bipolar plate substrate; and a byproduct-decomposing layer covering the bipolar plate substrate. The bipolar plate has channels for transport of a reactant gas, the channels being arranged on a surface of the bipolar plate substrate. The bipolar plate has a first side to face an anode catalyst layer of the fuel cell and a second side to face a cathode catalyst layer of the fuel cell. In the bipolar plate, the byproduct-decomposing layer is arranged on at least one of the first side and the second side, includes a catalyst, and is capable of decomposing a byproduct formed as a result of a reaction of the fuel cell.

In a preferred embodiment of the fuel-cell bipolar plate, the channels are space defined walls of grooves of a rib-and-groove structure formed on the bipolar plate substrate as part of their walls, or pores formed in a matrix of a porous medium layer arranged on a surface of the bipolar plate substrate.

In yet another preferred embodiment of the fuel-cell bipolar plate, the byproduct-decomposing layer is arranged on walls of the channels.

In still another preferred embodiment of the fuel-cell bipolar plate, part of the bipolar plate substrate or part of the matrix of the porous medium layer is to be in contact with the anode catalyst layer or the cathode catalyst layer.

The bipolar plate substrate or the matrix of the porous medium layer in the fuel-cell bipolar plate is preferably a conductor. As used herein the term “conductor” refers to a substance (material) having a volume resistivity of 10⁻² Q•m or less.

The byproduct-decomposing layer in the fuel-cell bipolar plate preferably contains one or more metallic elements selected from the group consisting of platinum, ruthenium, iridium, rhodium, osmium, palladium, tungsten,molybdenum, iron, cobalt, nickel and manganese.

In the fuel-cell bipolar plate, the byproduct-decomposing layer preferably further contains a binder; and one or more conducting agents selected from the group consisting of a carbon, an electroconductive ceramic and a metal powder.

The metallic element in the fuel-cell bipolar plate is preferably supported on the conducting agent.

The conducting agent for use in the fuel-cell bipolar plate preferably has a specific surface area of 10 m²/g or more.

The fuel cell preferably utilizes a reaction between an organic fuel and oxygen and includes the fuel-cell bipolar plate.

The fuel for use in the fuel cell preferably contains methanol.

The metallic element for use in the fuel cell is preferably palladium.

The fuel cell is preferably a fuel cell stack which has an assembly of a plurality of unit cells stacked on each other, and each of the unit cells includes an anode catalyst layer; a cathode catalyst layer; an electrolyte membrane interposed therebetween; and the fuel-cell bipolar plate.

The bipolar plate and the fuel cell will be illustrated in detail below, with reference to the attached drawings.

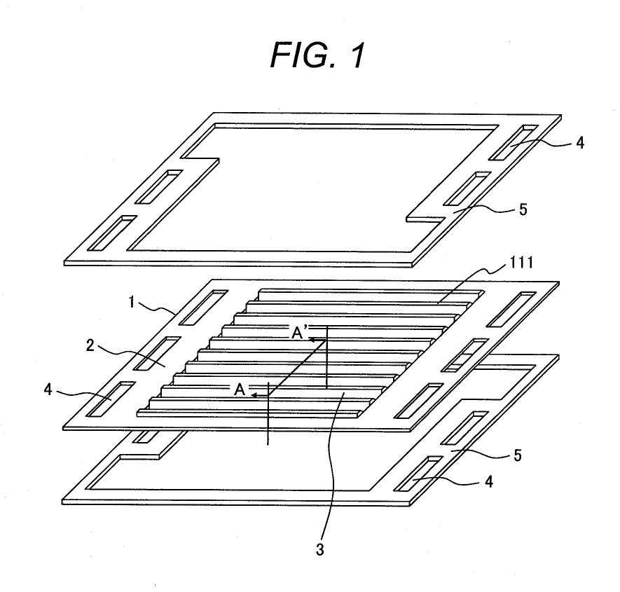

FIG. 1 is an exploded perspective view illustrating an exemplary structure of the bipolar plate. For the sake of comprehension, FIG. 1 also depicts a pair of gaskets 5, which holds the bipolar plate 1 therebetween from the front side and rear side of the bipolar plate 1.

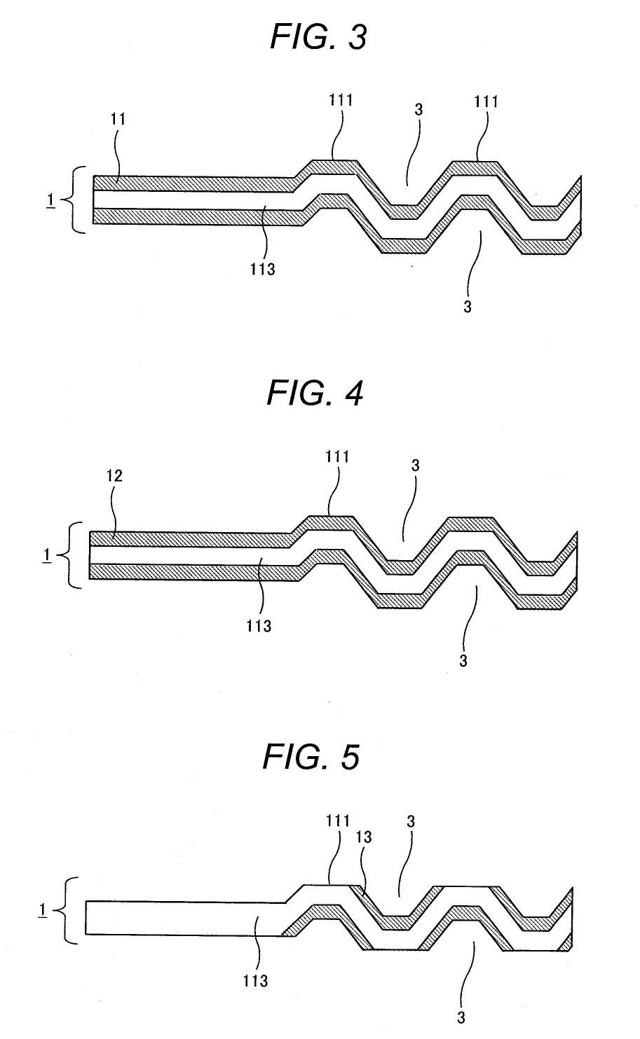

As illustrated in FIG. 3 mentioned later, the bipolar plate 1 includes a bipolar plate substrate 113 and a byproduct-decomposing layer 11 covering the bipolar plate substrate 113.

In the bipolar plate 1 illustrated in FIG. 1, a central part of a flat stainless steel (SUS steel) sheet serving as a bipolar plate substrate has been subjected to extrusion pressing to form a rib-and-groove structure having ribs 111 on the front and rear sides thereof to thereby constitute a plurality of channels 3. Specifically, the channels 3 are grooves of the rib-and-groove structure. In other words, the channels 3 are space defined by the grooves of the rib-and-groove structure. The bipolar plate 1 further includes a flat portion ’and manifolds 4 in the circumference thereof. As the substrate has been subjected to extrusion pressing, the channels 3 each have a trapezoidal sectional shape. After the extrusion pressing, a byproduct-decomposing layer is formed on the front side of the bipolar plate substrate.

The flat portion 2 serves as a portion to be in intimate contact with the gasket 5. The channels 3 are grooves for transfer or conduction of a reactant gas (this is a generic name for a fuel gas and an oxidant gas.) or cooling water to the front side and rear side of the bipolar plate 1 and are space defined by grooves (groove-shaped concave portions) of the rib-and-groove structure of the bipolar plate substrate as part of walls thereof. The manifolds 4 serve as inlet and outlet of the reactant gas and cooling water A gasketed bipolar plate is formed by bringing two plies of the gasket 5 into intimate contact with the flat portions 2 on the front and rear sides of the bipolar plate 1. The gasket 5 also has manifolds 4. In the gasketed bipolar plate, the manifolds 4 each penetrate from the front side to the rear side.

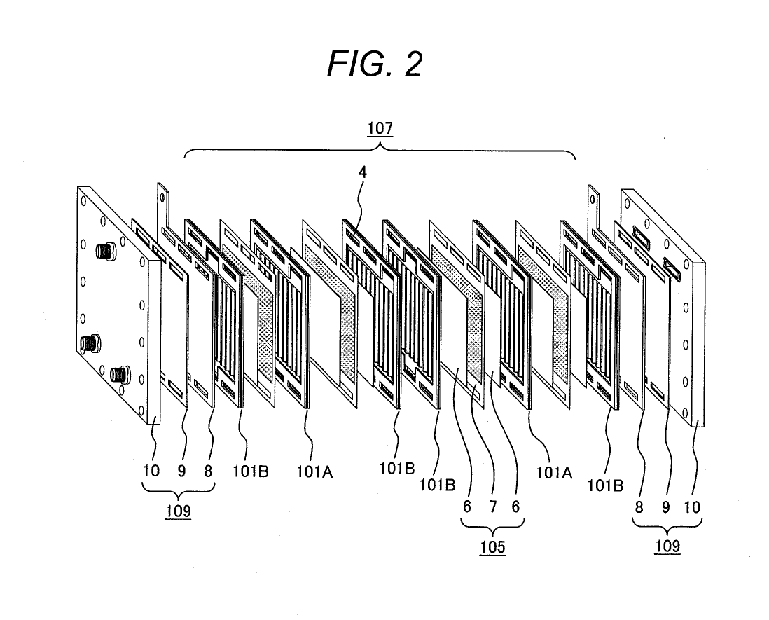

FIG. 2 is an exploded perspective view illustrating an exemplary structure of a fuel cell (hereinafter also simply referred to as a “cell”).

With reference to FIG. 2, a membrane electrode assembly 7 (MEA) is disposed between two gas diffusion layers 6 to form a unit cell 105. A plurality of the unit cells 105 are stacked so that each unit cell 105 is interposed between two gasketed bipolar plates 101A and 101B to form a cell stack 107. The cell stack 107 is disposed between two end structures 109 to form a fuel cell stack. The end structures 109 each include a current collector 8, an insulating plate 9 and an end plate 10.

The gasketed bipolar plates 101A and 101B have different structures from each other. In the gasketed bipolar plate 101A, channels on both sides thereof allow the reactant gas to flow therethrough; whereas, in the gasketed bipolar plate 101B, channels on one side thereof allow the reactant gas to flow therethrough, and channels on the other side allow cooling water to flow therethrough. Channels positioned inside the gasketed bipolar plate 101A or 101B holding the unit cells 105 allow the reactant gas to flow therethrough.

The highest surfaces (plateaus) of the ribs 111 of the bipolar plate 1 illustrated in FIG. 1 are in contact with the gas diffusion layer 6 which is a member serving to supply a gas to, and collect a current from the MEA serving as a power generation unit. The plateaus of the ribs 111 of the bipolar plate 1 should therefore be electroconductive. The other faces are unrelated to electric conduction, therefore does not need to have electric conductivity, and may be insulative or electroconductive.

FIG. 3 is a cross-sectional view illustrating an embodiment of the bipolar plate of FIG. 1, taken along the line A-A′ in FIG. 1.

When the fuel cell employs methanol as the fuel, reaction byproducts (hereinafter also simply referred to as “byproduct(s)”) such as formic acid and aldehydes are formed in the anode.

The bipolar plate 1 as illustrated in FIG. 3 includes a bipolar plate substrate 113; and a byproduct-decomposing layer 11 covering the bipolar plate substrate 113. The byproduct-decomposing layer 11 has the function of decomposing the reaction byproducts. In an embodiment illustrated in FIG. 3, overall of the front and rear sides of the bipolar plate substrate 113 are covered by the byproduct-decomposing layer 11. Specifically, even the plateaus of the ribs 111 of the bipolar plate 1 are covered by the byproduct-decomposing layer 11. Channels 3 as grooves are formed between adjacent ribs 111.

Exemplary materials for the bipolar plate substrate 113 include metallic materials such as iron, aluminum, copper, titanium, magnesium, zirconium, tantalum, niobium, tungsten, nickel, chromium, hafnium, zinc, bismuth and antimony, and alloys such as alloys of these metals, stainless steels, titanium alloys, copper alloys, and aluminum alloys which have undergone a surface treatment for corrosion protection; compact graphite (carbon graphite) ; and composite materials of a resin with carbon, an electroconductive metal or an electroconductive ceramic powder. When compact graphite is used, the rib-and-groove structure is typically preferably formed by cutting.

The byproduct-decomposing layer 11 has been formed by kneading a catalytic metal, at least one conducting agent selected typically from a carbon, an electroconductive ceramic and a metal powder, a binder for binding the conducting agent, and a solvent with one another to give a knead ate; and applying the knead ate to the substrate. The byproduct-decomposing layer 11 is therefore electroconductive. The catalytic metal may be in the form of a microparticulate powder as intact, but is preferably in the form of microparticles supported on an electroconductive support. Supporting on a support allows the catalytic metal to be used as microparticles having a size smaller than the support and to thereby have a large specific surface area. Supporting on a support also suppresses a deterioration phenomenon in which particles of the catalytic metal aggregate to form coarse particles to thereby have a smaller specific surface area.

The electroconductive support is preferably a carbon support, for satisfactory resistance to corrosion. The carbon support for use herein is preferably one having a specific surface area of 10 m²/g or more, for satisfactory dispersion of the catalytic metal. Exemplary carbon supports usable herein include carbon blacks, carbon nanotubes, carbon fibers and activated carbons. The specific surface area herein is measured by the nitrogen adsorption method in accordance with Japanese Industrial Standards (JIS) Z 8830.

Examples of the binder usable herein include fluorocarbon resins, silicone resins, phenolic resins, epoxy resins, polyimide resins, polyamide resins, polyolefinic resins, furan resins and rubber resins, and mixtures of them.

The bipolar plate 1 can decompose reaction byproducts on its surface and can thereby provide a fuel cell stack which controls discharges of reaction byproducts over the long term as the bipolar plate 1 has this configuration.

FIG. 4 is a cross-sectional view illustrating another embodiment of the bipolar plate of FIG. 1, taken along the line A-A′ in FIG. 1.

When the fuel cell employs methanol as the fuel, a large amount of formic acid as a reaction byproduct is formed in the anode.

The embodiment illustrated in FIG. 4 specifically employs a catalyst for the decompositions of formic acid.

With reference to FIG. 4, the bipolar plate 1 has a bipolar plate substrate 113 and a formic-acid-decomposing layer 12 covering overall the front and rear sides (both sides) of the bipolar plate substrate 113. The formic-acid-decomposing layer 12 is an example (specific embodiment) of the byproduct-decomposing layer 11 in FIG. 3. In other words, the catalyst for the decomposition of formic acid is an example of the catalyst for use in the byproduct-decomposing layer 11. The formic-acid-decomposing layer 12 has been formed by kneading a catalytic metal, at least one conducting agent selected typically from a carbon, an electroconductive ceramic, and a metal powder, a binder for binding the conducting agent, a polymer electrolyte, and a solvent with one another to give a kneadate; and applying the kneadate to the substrate. The formic-acid-decomposing layer 12 is therefore electroconductive and proton-conductive. The catalyst metal for use herein is particularly preferably palladium.

It is not preferable that the catalytic metal for use in the formic-acid-decomposing layer 12 contains a catalyst accelerating a methanol oxidation reaction, which is exemplified by platinum, ruthenium, iridium, rhodium, osmium, tungsten, molybdenum, iron, cobalt, nickel and manganese. In particular, it is not preferable that the catalytic metal contains a composite catalyst containing platinum and ruthenium as components. Such a catalyst accelerating the methanol oxidation reaction may cause the methanol oxidation reaction to occur in the formic-acid-decomposing layer 12 to give formic acid again as an intermediate, if the catalyst contained in the formic-acid-decomposing layer 12, and this reduces efficiency in suppression of formic acid discharge.

Palladium serving as the catalyst for formic acid oxidation little functions as a catalyst for the methanol oxidation reaction and causes little increase in formic acid, even when used. Palladium is preferably used as microparticles supported on a support. Supporting on the support allows the catalytic metal (palladium) to be used as microparticles having a size smaller than the support to thereby have a large specific surface area.

Exemplary materials for the polymer electrolyte membrane include sulfonated fluorocarbon polymers typified by poly(perfluorostyrenesulfonic acid)s and poly(perfluorocarbon sulfonic acid)s; sulfonated hydrocarbon polymer materials such as poly(styrenesulfonic acid)s, sulfonated polyethersulfones and sulfonated poly(ether ether ketone)s; and alkylsulfonated hydrocarbon polymer materials.

The bipolar plate 1 can decompose formic acid as a reaction byproduct on its surface and can thereby provide a fuel cell stack which controls discharge of formic acid over the long term, as the bipolar plate 1 having this configuration.

FIG. 5 is a cross-sectional view illustrating still another embodiment of the bipolar plate of FIG. 1, taken along the line A-A′ in FIG. 1.

Methanol passes through the electrolyte membrane to the cathode, and reacts on the cathode to give formic acid as a reaction byproduct, when methanol is used as the fuel. Air is fed to the cathode, and formic acid can be oxidized by the action of oxygen in the air. For this reason, the cathode does not need electrochemically oxidization of formic acid, unlike the anode.

In the cathode, therefore, it is enough that the formic-acid-decomposing layer 13 is formed or arranged only in portions of the ribs 111 other than the plateaus requiring electroconductivity in the bipolar plate 1, as illustrated in FIG. 5. The other portions correspond to the channels 3 through which reaction substances are conducted or transferred. In other words, the formic-acid-decomposing layer 13 is provided only on walls of the channels 3. In this embodiment, the ribs 111 (plateaus) where the bipolar plate substrate 113 is exposed are to be in contact with the anode catalyst layer or cathode catalyst layer.

The formic-acid-decomposing layer 13 has been formed by kneading a catalytic metal or a support (e.g., a carbon, an electroconductive ceramic, or a metal powder) supporting the catalytic metal with a resin binder for binding the catalytic metal or the support, to give a kneadate; and applying the kneadate to the substrate. Preferred examples of the catalyst for use in the formic-acid-decomposing layer 13 include catalysts accelerating the oxidation reaction of formic acid such as platinum, ruthenium, iridium, rhodium, osmium, palladium, tungsten, molybdenum, iron, cobalt, nickel and manganese. Among them, palladium is particularly preferred. Such a formic acid oxidation catalyst is preferably used as microparticles supported on a support. Supporting on a support allows the catalytic metal to be used as microparticles having a size smaller than the support to thereby have a large specific surface area.

The bipolar plate 1 can decompose formic acid as a reaction byproduct on its surface and can thereby provide a fuel cell stack which controls the discharge of formic acid over the long term, as the bipolar plate 1 having this configuration.

In the embodiments illustrated in FIGS. 1 to 5, the channels 3 have a trapezoidal sectional shape. The sectional shape of the channels 3 is, however, not limited thereto, and may be, for example, a rectangular or semi-circular shape. The channels 3 may also have a complicated sectional shape, such as pores in a porous article.

Methanol fuel cells will be illustrated below as working examples.

### WORKING EXAMPLE 1

Compact graphite was used as a material for a bipolar plate substrate. The compact graphite was subjected to cutting to give a bipolar plate substrate having gas channels (channels) 1 mm wide and 1 mm deep, and 1-mm ribs to be in contact with a gas diffusion layer. The resulting unit cell was designed to have a power generation area of 25 cm². The channels each have a rectangular sectional shape.

A slurry for an anode-side formic-acid-decomposing layer was prepared by mixing a palladium-supporting carbon black, Nafion (registered trademark) serving as a polymer electrolyte, propanol and water with one another, followed by stirring with a stirrer for 24 hours. The slurry was applied to the surface of the above-prepared bipolar plate to a mass of palladium of 0.4 mg/cm² through spray coating, held in a thermostat at 120° C. for one hour to form a formic-acid-decomposing layer on the surface of the bipolar plate substrate, and thereby yielded an anode-side bipolar plate.

As a bipolar plate to face to a cathode (cathode-side bipolar plate), the above-prepared bipolar plate substrate after cutting but without the formation of formic-acid-decomposing layer was used.

A fuel cell (unit cell) was prepared by using the anode-side bipolar plate and the cathode-side bipolar plate.

In this example, the formic-acid-decomposing layer has a thickness of about 40 μm.

### WORKING EXAMPLE 2

Compact graphite was used as a material for a bipolar plate substrate. The compact graphite was subjected to cutting to give a bipolar plate substrate having gas channels (channels) 1 mm wide and 1 mm deep, and 1-mm ribs to be in contact with a gas diffusion layer. The resulting unit cell was designed to have a power generation area of 25 cm².

A slurry for a cathode-side formic-acid-decomposing layer was prepared by mixing a palladium-supporting carbon black, a binder vinylidene fluoride, and a solvent N-methyl-2-pyrrolidone with one another. The slurry was applied only to walls of the channels to a mass of palladium of 0.4 mg/cm² by spray coating, while masking ribs of the bipolar plate substrate. The coated slurry was held in a thermostat at 140° C. for 3 hours to form a formic-acid-decomposing layer on the surface of the bipolar plate substrate, and thereby yielded a cathode-side bipolar plate.

As an anode-side bipolar plate, the above-prepared bipolar plate substrate after cutting but without the formation of formic-acid-decomposing layer was used.

A fuel cell (unit cell) was prepared by using the anode-side bipolar plate and the cathode-side bipolar plate.

In this example, the formic-acid-decomposing layer has a thickness of about 30 μm.

### WORKING EXAMPLE 3

A fuel cell (unit cell) was prepared by using the anode-side bipolar plate prepared in Working Example 1 and the cathode-side bipolar plate prepared in Working Example 2.

### COMPARATIVE EXAMPLE 1

Compact graphite was used as a material for a bipolar plate. The compact graphite was subjected to cutting to give a bipolar plate having gas channels (channels) 1 mm wide and 1 mm deep, and 1-mm ribs to be in contact with a gas diffusion layer. The resulting unit cell was designed to have a power generation area of 25 cm². A fuel cell was prepared by using the bipolar plate without formation of a formic-acid-decomposing layer on the surface of the bipolar plate.

(Evaluations)

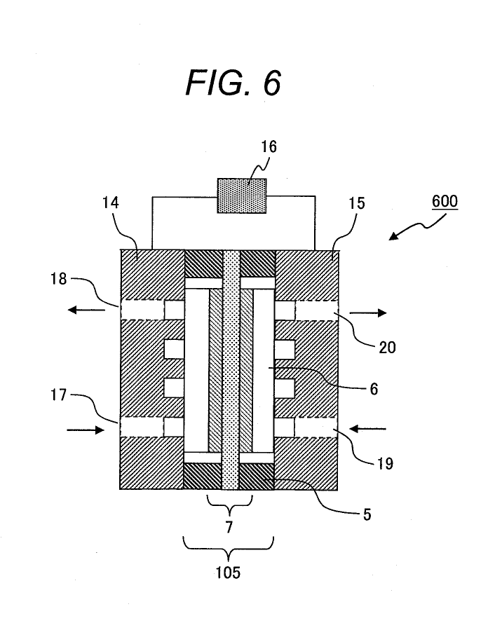

FIG. 6 is a schematic cross-sectional view illustrating a fuel cell used for the evaluation of the Working Examples and a Comparative Example.

The fuel cell 600 includes a unit cell 105 including a pair of gas diffusion layers 6 and a membrane electrode assembly (MEA) 7 interposed between them, an anode-side bipolar plate 14 equipped with a gasket 5, and a cathode-side bipolar plate 15 equipped with a gasket 5, the unit cell 105 being interposed between the bipolar plates 14 and 15. The anode-side bipolar plate 14 is provided with a methanol aqueous solution supply port 17 and a discharge liquid outlet 18 which enable supply of the fuel methanol and drainage of a discharge liquid (waste liquid) including a reaction product. The cathode-side bipolar plate 15 is provided with an air supply port 19 and an exhaust gas outlet 20 which enable supply of air as an oxidant and emission of an exhaust gas including a reaction product. The fuel cell 600 is connected to an external circuit 16 for electrical discharging.

The membrane electrode assembly (MEA) 7 including a polymer electrolyte membrane, an anode catalyst layer and a cathode catalyst layer was prepared in the following manner.

An anode slurry was prepared by mixing a platinum/ruthenium-supporting carbon black, a polymer electrolyte Nation (registered trademark), propanol and water with one another, followed by stirring with a stirrer for 24 hours. Independently, a cathode slurry was prepared by mixing a platinum-supporting carbon black, Nation (registered trademark), propanol and water with one another, followed by stirring with a stirrer for 24 hours.

Next, the anode slurry was applied through spray coating to one side of a polymer electrolyte membrane made from a sulfonated polyethersulfone, and the cathode slurry was then applied to the other side of the polymer electrolyte membrane through spray coating. The resulting article was hot-pressed at 120° C. to give a MEA.

A fuel cell was prepared by sandwiching the above-prepared MEA between a carbon paper which is an anode-side diffusion layer (anode diffusion layer) and a carbon cloth which is a cathode-side diffusion layer (cathode diffusion layer), and further sandwiching them between the anode-side bipolar plate 14 and the cathode-side bipolar plate 15 prepared in the Working Examples and Comparative Example, and clamping them under a predetermined pressure.

In the evaluations of the samples obtained from the Working Examples and Comparative Example, a methanol aqueous solution containing 3 percent by weight of methanol was fed as the fuel; whereas air with relative humidity of 60% was fed to the cathode. The cell temperature was 60° C., and the load current density was 0.15 A/cm². The formic acid discharge in this process (testing process) was determined by collecting the waste liquid discharged from the discharge liquid outlet 18 and the exhaust gas emitted from the exhaust gas outlet 20 into iced water, and measuring the amount of formic acid contained in the iced water through ion chromatography.

Table 1 indicates measurement results of formic acid discharge.

TABLE 1

| | Formic-acid- | | Formic acid |
|---|---|---|---|
| Bipolar plate | decomposing layer | Catalyst | discharge (mg/hr) |
| Working | Anode side | Pd | 7 |
| Example 1 | | | |
| Working | Cathode side | Pd | 40 |
| Example 2 | | | |
| Working | Anode side and | Pd | 1 |
| Example 3 | cathode side | | |
| Comparative | None | — | 52 |
| Example 1 | | | |

The bipolar plate according to the Working Example 3 including formic-acid-decomposing layers both on anode and cathode sides has a small formic acid discharge of about one-fiftieth that of the bipolar plate according to the Comparative Example 1 including no formic-acid-decomposing layer. The fuel cell according to the Working Example 2 has a large formic acid discharge of about 6 times that of the fuel cell according to the Working Example 1. This demonstrates that the total discharge of formic acid can be effectively reduced when the formic-acid-decomposing layer is provided on the anode side, because formic acid is formed in a larger amount in the anode than in the cathode.

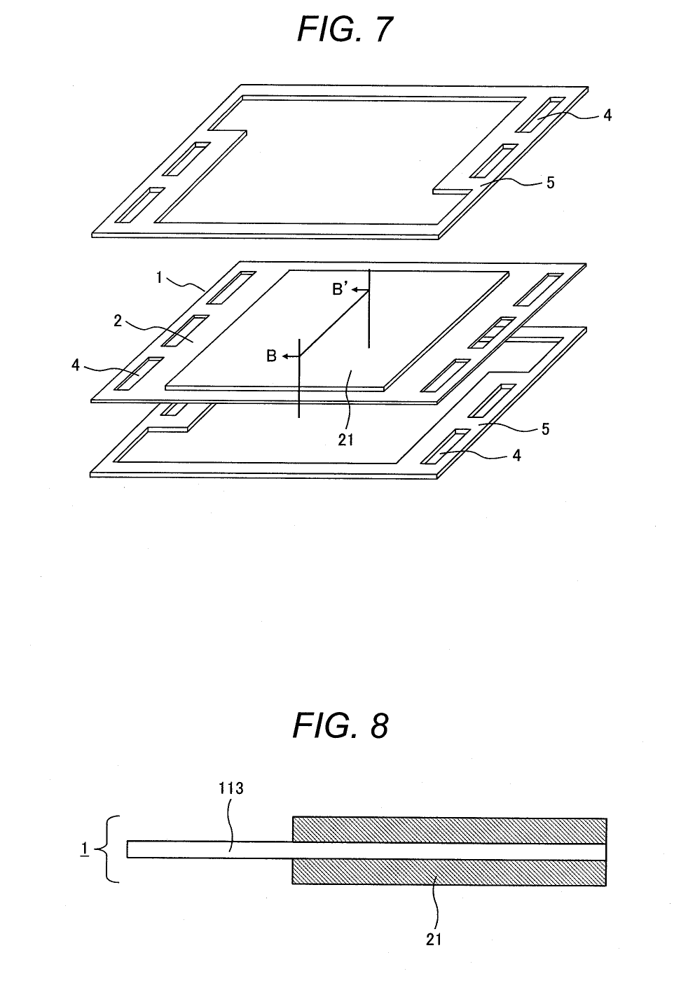

FIG. 7 is an exploded perspective view illustrating yet another embodiment of the structure of the bipolar plate.

In the bipolar plate 1 illustrated in FIG. 7, reactant gas channels are provided in a center part of the bipolar plate 1 and are defined by an electroconductive porous article. Specifically, the channels are defined as pores formed in the porous medium layer 21. The pores communicate to the outside. In other words, the channels are pores defined by the matrix (base material) of the porous medium layer 21.

FIG. 8 is a cross-sectional view of the bipolar plate of FIG. 7, taken along the line B-B′ in FIG. 7.

With reference to FIG. 8, the bipolar plate 1 includes a flat and tabular bipolar plate substrate 113 and a porous medium layer 21. A byproduct-decomposing layer is formed so as to cover walls constituting or defining pores in the porous medium layer 21. The byproduct-decomposing layer can therefore have a large surface area and can decompose a byproduct efficiently. This reduces or controls the discharge of the byproduct.

What is claimed is:

1. A bipolar plate for a fuel cell comprising:
a bipolar plate substrate; and
a byproduct-decomposing layer covering the bipolar plate substrate,
the bipolar plate having channels for transport of a reactant gas, the channels being arranged on a surface of the bipolar plate substrate,
the bipolar plate having a first side to face an anode catalyst layer of the fuel cell and a second side to face a cathode catalyst layer of the fuel cell,
wherein the byproduct-decomposing layer is arranged on at least one of the first side and the second side, includes a catalyst, and is capable of decomposing a byproduct formed as a result of a reaction of the fuel cell.

2. The bipolar plate according to claim 1,
wherein the channels are space defined walls of grooves of a rib-and-groove structure formed on the bipolar plate substrate as part of their walls, or pores formed in a matrix of a porous medium layer arranged on a surface of the bipolar plate substrate.

3. The bipolar plate according to claim 1,
wherein the byproduct-decomposing layer is arranged on walls of the channels.

4. The bipolar plate according to claim 2,
wherein part of the bipolar plate substrate or part of the matrix of the porous medium layer is to be in contact with the anode catalyst layer or the cathode catalyst layer.

5. The bipolar plate according to claim 4,
wherein the bipolar plate substrate or the matrix of the porous medium layer is a conductor.

6. The bipolar plate according to claim 1,
wherein the byproduct-decomposing layer contains one or more metallic elements selected from the group consisting of platinum, ruthenium, iridium, rhodium, osmium, palladium, tungsten, molybdenum, iron, cobalt, nickel and manganese.

7. The bipolar plate according to claim 6,
wherein the byproduct-decomposing layer further contains a binder; and one or more conducting agents selected from the group consisting of a carbon, an electroconductive ceramic and a metal powder.

8. The bipolar plate according to claim 6,
wherein the metallic element is supported on the conducting agent.

9. The bipolar plate according to claim 7,
wherein the conducting agent has a specific surface area of 10 m²/g or more.

10. A fuel cell utilizing a reaction between an organic fuel and oxygen, the fuel cell comprising the bipolar plate of claim 1.

11. The fuel cell according to claim 10,
wherein the fuel comprises methanol.

12. The fuel cell according to claim 10,
wherein the metallic element is palladium.

13. A fuel cell stack comprising an assembly of a plurality of unit cells stacked on each other, the unit cells each including:
an anode catalyst layer;
a cathode catalyst layer;
an electrolyte membrane interposed therebetween; and
the bipolar plate of claim 1.
